(19) United States
(12) Patent Application Publication
(10) Pub. No.: US 2013/0317834 A1
(43) Pub. Date: Nov. 28, 2013

(54) CUSTOMIZED AND INTUITIVE ANTIBIOGRAMS

(71) Applicants: Hugh Ryan, Lee's Summit, MO (US); Brent Nightingale, Kansas City, MO (US); Michael Curry, Independence, MO (US); Phil Stadler, Olathe, KS (US)

(72) Inventors: Hugh Ryan, Lee's Summit, MO (US); Brent Nightingale, Kansas City, MO (US); Michael Curry, Independence, MO (US); Phil Stadler, Olathe, KS (US)

(73) Assignee: CERNER INNOVATION, INC., Overland Park, KS (US)

(21) Appl. No.: 13/479,365

(22) Filed: May 24, 2012

(51) Int. Cl. G06Q 50/22

(52) U.S. Cl. 705/2

(57) ABSTRACT

Methods, computer systems, and computer storage media are provided for utilizing a healthcare facility's antibiogram information to generate customized antibiograms. One or more user-selected filters are applied to the information in the antibiogram data store. Filters include organism type, antimicrobial type, date range, encounter type, healthcare facility unit, and end-user role. Using the selected filters, a customized antibiogram is generated and presented on a user interface.

### BACKGROUND

An antibiogram is the result of a laboratory testing for the sensitivity or susceptibility of isolated bacterial strains to different antimicrobials. A healthcare facility typically compiles antibiogram information on susceptibility rates of various organisms, cultured within the healthcare facility, to different antimicrobials. The antibiogram is used by hospital microbiologists, physicians, pharmacists, nurses, and quality improvement personnel to guide individual patient antimicrobial therapy as well as policies within the healthcare facility concerning the effective utilization of antimicrobials.

Traditionally, an antibiogram is generated by providing a variety of statistical reports detailing organisms and their susceptibility rates against various antimicrobials to an antimicrobial committee at a healthcare facility. The committee determines what organisms and antimicrobials should be included in the antibiogram. The decision concerning the types of organisms and antimicrobials to include in the antibiogram is made at a facility level. In other words, the antibiogram is created for the healthcare facility as a whole without regard to the different types of the people who will actually be viewing and using the information. For instance, the same antibiogram is presented to a nurse and an infectious disease physician. Further, there is typically no customization by location within the healthcare facility, patient, encounter type, specimen type, etc.

Once the decision is made as to which organisms and antimicrobials to include in the antibiogram, the antibiogram is formatted and printed; it is then distributed in a paper form to staff at the healthcare facility. This process generally occurs annually or possibly biannually, but typically not any more frequently than annually. A representative antibiogram includes for example, an alphabetized list of the top ten to twenty organisms cultured at the healthcare facility and an alphabetized listing of antimicrobials that are stocked by the facility's pharmacy. Additionally, the representative antibiogram includes susceptibility rates of the organisms to the different antimicrobials tested against the organisms. Any type of cross-referencing or antimicrobial-to-organism comparison must be done manually by the end user.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief, and at a high level, methods, systems, and computer storage media provide for creating a customized antibiogram. A healthcare facility's antibiogram data store is accessed. One or more user-selected filters are applied to data stored in association with the antibiogram data store. The filters may include, for example, an end-user role, locations within the healthcare facility, types of organisms, types of antimicrobials, patient(s), date ranges, encounter type, specimen type, and the like. A customized antibiogram is generated based on the filtered data. The customized antibiogram is electronically presented to the end user, and the end user can further interact with the antibiogram to cross-reference data, view more detailed information concerning an organism or antimicrobial, and use the antibiogram to guide clinical decision making especially at the empiric-therapy stage.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system for generating a customized antibiogram suitable to implement embodiments of the present invention;

FIG. 3 depicts an exemplary graphical user interface for enabling an end user to access a customized antibiogram in accordance with an embodiment of the present invention;

FIG. 4 depicts an exemplary graphical user for presenting a customized antibiogram in accordance with an embodiment of the present invention;

FIG. 5 depicts an exemplary graphical user interface for presenting an organism detail view in accordance with an embodiment of the present invention;

FIG. 6 depicts an exemplary graphical user interface for presenting susceptibility rate information and price information to a clinician during an empiric therapy decision stage in accordance with an embodiment of the present invention; and

FIGS. 7-9 are flow diagrams that illustrate exemplary methods of generating a customized antibiogram in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer storage media for creating a customized antibiogram. A healthcare facility's antibiogram data store is accessed. One or more user-selected filters are applied to data stored in association with the antibiogram data store. The filters may include, for example, an end-user role, locations within the healthcare facility, types of organisms, types of antimicrobials, patient(s), date ranges, encounter type, specimen type, and the like. A customized antibiogram is generated based on the filtered data. The customized antibiogram is electronically presented to the end user, and the end user can further interact with the antibiogram to cross-reference data, view more detailed information concerning an organism or antimicrobial, and use the antibiogram to guide clinical decision making especially at the empiric-therapy stage.

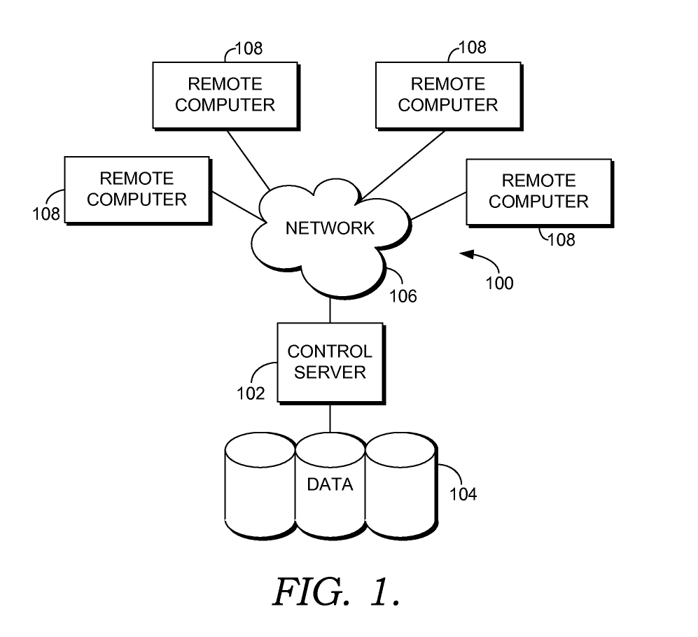

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

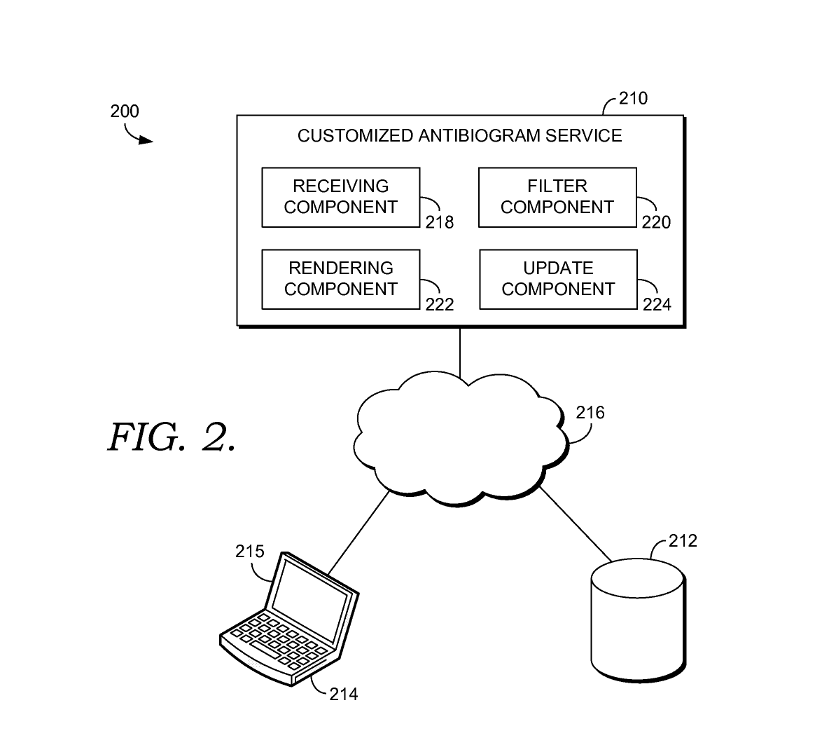

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a customized antibiogram service 210, a data store 212, and an end-user computing device 214 with a display screen 215 all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

In some embodiments, one or more of the illustrated components/modules may be implemented as stand-alone applications. In other embodiments, one or more of the illustrated components/modules may be integrated directly into the operating system of the customized antibiogram service 210. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the customized antibiogram service 210 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the customized antibiogram service 210. The information stored in association with the data store 212 is configured to be searchable for one or more items of information stored in association therewith. The information stored in association with the data store 212 may comprise general information used by the customized antibiogram service 210.

For example, the data store 212 may store antibiogram information. The antibiogram information may include organisms that have been cultured at one or more healthcare facilities. The information may also include susceptibility rates of the organisms against one or more antimicrobials. Other antibiogram information stored in association with the data store 212 includes isolate counts, facility-specific cost information associated with the antimicrobials, facility-specific information regarding testing protocols and classification schemes, dates for when susceptibility rates were determined, where in a healthcare facility the organism(s) was isolated, patients from whom the organism(s) was isolated, specimen type (urine, blood, central nervous system (CNS), wound, sputum, etc.), encounter type (emergency room visit, post-surgical patient, recently discharged patient, etc.), and the like. The data store 212 may store antibiogram information concerning one healthcare facility, multiple healthcare facilities, community or county-wide health centers, and the like.

In one aspect, antibiogram information stored in association with the data store 212 may be updated using a fixed schedule. For example, the antibiogram information may be updated daily, weekly, monthly, and the like. In another aspect, the antibiogram information may be updated whenever new antibiogram information is received. For instance, culture results may be determined for a patient, and the data store 212 is immediately updated upon receipt of the culture results.

The data store 212 may also store electronic medical records (EMRs) of patients associated with one or more healthcare facilities. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

Additionally, the data store 212 may store information concerning decision-support algorithms, reference materials, standards of care, recommendation protocols, and the like. This information may be specific to a healthcare facility, or the information may be promulgated by, for example, nationally-recognized medical organizations or governing bodies.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the customized antibiogram service 210, the end-user computing device 214, and/or any combination thereof.

As shown, the end-user computing device 214 includes a display screen 215. The display screen 215 is configured to display information to the user of the end-user computing device 214, for instance, information relevant to communications initiated by and/or received by the end-user computing device 214, antibiogram information, and/or the like. Embodiments are not intended to be limited to visual display but rather may also include audio presentation, combined audio/visual presentation, and the like. The end-user computing device 215 may be any type of display device suitable for presenting a graphical user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions.

Components of the customized antibiogram service 210 may include a processing unit, internal system memory, and a suitable system bus for coupling various system components, including one or more data stores for storing information (e.g., files and metadata associated therewith). The customized antibiogram service 210 typically includes, or has access to, a variety of computer-readable media.

The computing system environment 200 is merely exemplary. While the customized antibiogram service 210 is illustrated as a single unit, it will be appreciated that the customized antibiogram service 210 is scalable. For example, the customized antibiogram service 210 may in actuality include a plurality of computing devices in communication with one another. Moreover, the data store 212, or portions thereof, may be included within, for instance, the customized antibiogram service 210 as a computer-storage medium. The single unit depictions are meant for clarity, not to limit the scope of embodiments in any form.

As shown in FIG. 2, the customized antibiogram service 210 comprises a receiving component 218, a filter component 220, a rendering component 222, and an update component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the remote computer 108 of FIG. 1. It will be understood that the components 218, 220, 222, and 224 illustrated in FIG. 2 are exemplary in nature and in number and should not be construed as limiting. Any number of components may be employed to achieve the desired functionality within the scope of embodiments hereof.

The receiving component 218 is configured to receive user selections, filters, requests, or inputs. For the purposes of this application, a user may be defined as an employee of a healthcare facility (nurse, administrator, lab personnel, pharmacist, therapist, etc.), or a clinician associated with the healthcare facility (i.e., a clinician who has hospital privileges at the healthcare facility).

The receiving component 218 may receive the user selections from a computing device associated with the healthcare facility such as, for example, the remote computing device 108 of FIG. 1. The receiving component 218 may also receive user selections from a computing device associated with a clinician who, in turn, is associated with the healthcare facility. For instance, a clinician may be away from the healthcare facility and utilize a remote computing device to input one or more user selections, commands, filters, etc.

The filter component 220 is configured to receive user-selected inputs or filters and apply the filters to data stored in association with the healthcare facility's antibiogram data store. In turn, the facility's antibiogram data store may be stored in association with the data store 212. The filters may be dependent upon criteria such as location or unit within the healthcare facility, one or more patients associated with the healthcare facility, an encounter type associated with the healthcare facility, and/or a role of the user. Location filtering is important because of the difference in types of organisms and organism susceptibility rates of organisms cultured from different locations within the healthcare facility. For example, organisms cultured from an intensive care unit (ICU) or a long-term stay unit are generally associated with hospital-acquired infections. These organisms may be difficult to treat because of higher-than-normal resistance rates among the organisms. Organisms cultured from the ICU or long-term stay unit differ from organisms isolated from, for example, an emergency room. Organisms isolated from emergency rooms are generally associated with community-acquired infections such as impetigo and community-acquired pneumonia and are more susceptible to common antimicrobials.

Filters may also be dependent on one or more patients associated with the healthcare facility. For example, a clinician may care for a patient who suffers from chronic infections. Such patients may include HIV positive or AIDS patients, patients who suffer from chronic wounds secondary to, for example, circulatory problems, cystic fibrosis patients, and the like. These types of patients typically have had multiple cultures spanning a number of years and have patient-specific antibiogram information detailing the types of organisms typically cultured along with susceptibility rates to different antimicrobials.

Filters may also be dependent upon encounter types within the healthcare facility. Like with locations within the healthcare facility, types of organisms and organism susceptibility rates are dependent upon different encounter types. Encounter types may include post-discharge visits, observational stays, emergency room visits, surgical patients, patients with infections, patients on ventilators, patients on prophylactic antibiotic therapy, patients who have been cared for by multiple venues, patients who have encountered venues with higher-than-normal resistance rates, patients with previous infections who may be experiencing occult infections, and the like.

Filters may also be dependent upon end-user roles. User roles may comprise broad categories such as pharmacists, nurses, therapists, laboratory personnel, and physicians. The roles may be further stratified. For example, roles may be stratified by department (ICU versus emergency room), or specialty (infectious disease physicians, emergency room physicians, surgeons, wound care nurse, ICU nurse, etc.). Each of these different end user roles has a need for different types of antiobiogram information. For example, an infectious disease physician may expect a great deal of information concerning organisms, susceptibility rates and antimicrobials because they are treating a wide-range of patients having a wide-range of infection types. By contrast, an emergency room physician would primarily require information concerning organisms that cause community-acquired infections.

Filters may also be dependent upon type of organism and antimicrobials. Like above, different users may be interested in different types of organisms and may filter accordingly. By way of illustrative example, a microbiologist associated with the hospital may want to track susceptibility rates of a particular organism over time, while a surgeon may want to view a set of organisms that typically cause post-surgical infections. With respect to antimicrobials, a user may select one or more antimicrobials based on, for example, cost, efficacy, availability, and the like. Other exemplary filters include filters based on a user-specified date range, minimum result counts, and specimen type. Specimen type, in turn, includes sputum, central nervous system (CNS), blood, urine, wound, feces, and the like.

The customized antibiogram service 210 further includes the rendering component 222. The rendering component 222 is configured to render or generate one or more customized antibiograms using the data filtered by the filter component 220. The rendering component 222 is further configured to present the customized antibiogram on a user interface of a computing device associated with the healthcare facility or a computing device of a clinician associated with the healthcare facility. For instance, the customized antibiogram may be presented in association with an electronic chart or an electronic order form used during an empiric-therapy decision stage.

The update component 224 of the customized antibiogram service 210 is configured to receive new or modified antibiogram information and update, for example, the data store 212 with the received antibiogram information. In one aspect, the update component 224 is configured to update the data store 212 on a predetermined schedule. The schedule may be daily, weekly, monthly, or longer. In another aspect, the update component 224 is configured to update the data store 212 whenever new or modified antibiogram information is received.

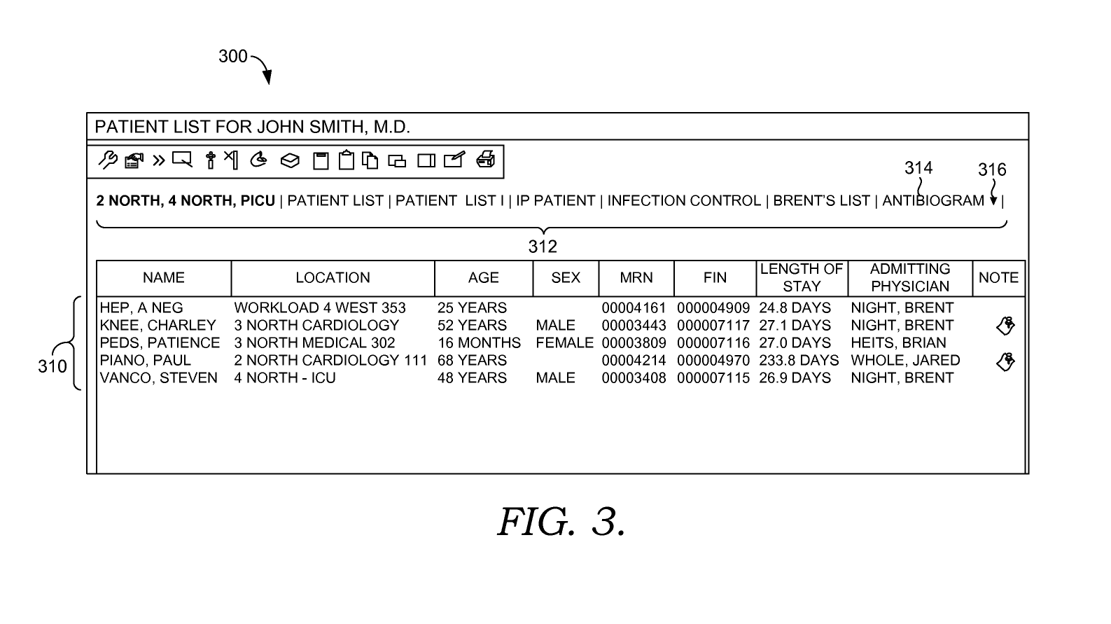

FIG. 3 depicts an exemplary graphical user interface (GUI) 300 of an electronic chart by which a user can access his or her customized antibiogram. The GUI 300 includes a list of options 312 accessible via the electronic chart. The options 312 are specific to the user (in this case, John Smith M.D.). Each option 312 is selectable, and currently the user has selected a patient list 310 corresponding to 2 North, 4 North, and the PICU. The list of options 312 further includes an antibiogram option 314 enabling the user to select one or more customized antibiograms. The antibiogram option 314 includes a drop down list (shown by the arrow 316) that, when selected, presents one or more antibiograms associated with the user. The customized antibiograms may be based on, for example, location, user role, encounter type, patients, organism type, antimicrobial type, and the like.

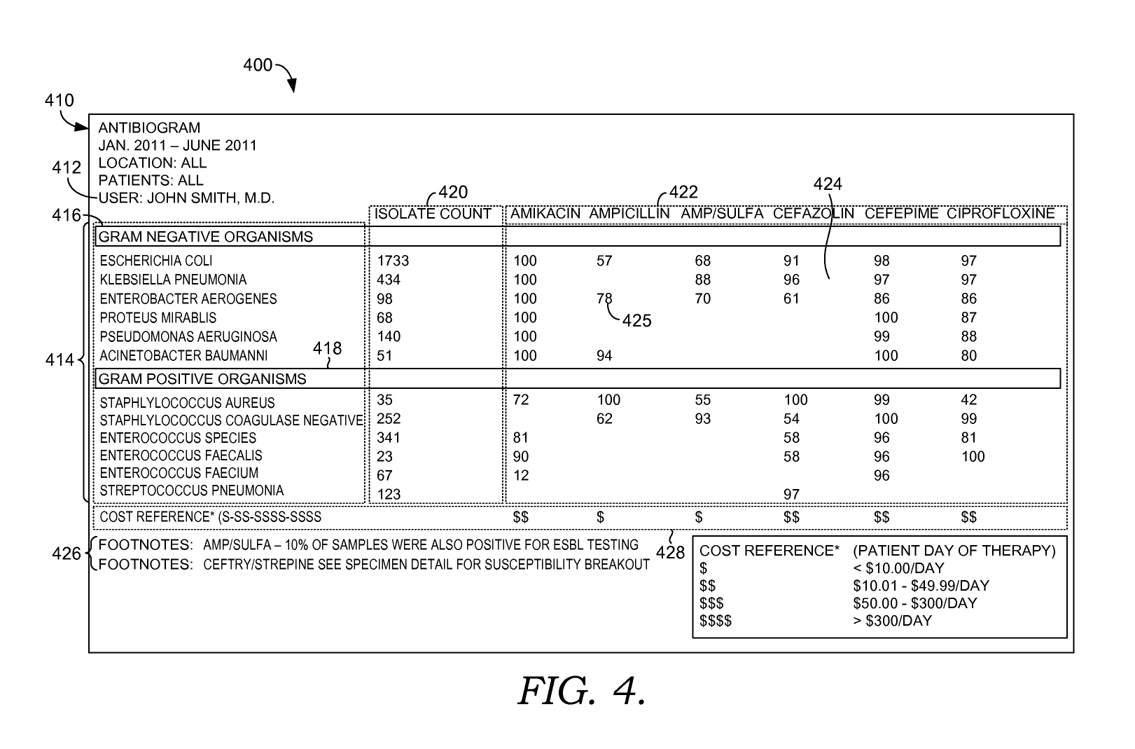

FIG. 4 depicts an exemplary graphical user interface (GUI) 400 that is presented upon the user selecting an antibiogram option on the GUI 300 (e.g., antibiogram option 314). The GUI 400 includes a user display area 412 that displays the name of the user. It also includes a date display area 410 that displays a user-selected date range for the antibiogram.

Continuing, the GUI 400 has an organism display area 414 configured to display one or more user-selected organisms. The organism display area 414 may be further divided into a gram-negative organism display area 416 and a gram-positive organism display area 418. Dividing organisms into gram-positive and gram-negative types is helpful when a clinician is deciding on an appropriate empiric therapy. Empiric therapy refers to the initiation of, in this case, antimicrobial therapy prior to receiving culture results. Starting therapy prior to obtaining culture results may be needed if the patient presents with signs and symptoms of an infection. For example, it typically takes three to four days to culture an organism and determine its susceptibility to one or more antimicrobials. This is too long of a period to wait before initiating treatment. However, gram stain information can often be obtained within a couple of hours after obtaining a specimen from a patient. Because gram-positive organisms and gram-negative organisms have different susceptibility profiles to antimicrobials, dividing the organism display area 414 into the gram-positive section 418 and the gram-negative section 416 is useful and helps the clinician to more quickly decide on an empiric therapy.

The GUI 400 also includes an isolate count display area 420 configured to present a numerical value indicating how often any one organism was cultured within the healthcare facility (or unit, or in association with an encounter type or a patient) within the designated time range. This information is important in identifying the frequency of occurrence of infections caused by that organism. The GUI 400 further includes an antimicrobial display area 422 configured to display one or more user-selected antimicrobials. A susceptibility display area 424 is configured to display susceptibility rates for the organisms in the organism display area 414 to one or more of the antimicrobials in the antimicrobial display area 422. Susceptibility rates are typically presented as a percentage indicating the percentage of the organisms that are susceptible to an antimicrobial. For example, the antimicrobial Ampicillin kills 78% (element 425) of the organism Enterobacter aerogenes. Thus, the higher the susceptibility rate, the more susceptible an organism is to an antimicrobial.

The GUI 400 additionally includes a footnote display area 426 configured to display one or more footnotes. The footnotes in the footnote display area 426 may be inputted by, for example, a microbiologist or laboratory personnel associated with the healthcare facility and represent facility-specific information regarding, for example, classification schemes for organisms or antimicrobials and/or testing protocols. Further, the GUI 400 has a cost reference display area 428 configured to display healthcare facility costs for the one or more antimicrobials. Providing this type of information enables the clinician to select an antimicrobial that is both effective against an organism and is cost-efficient.

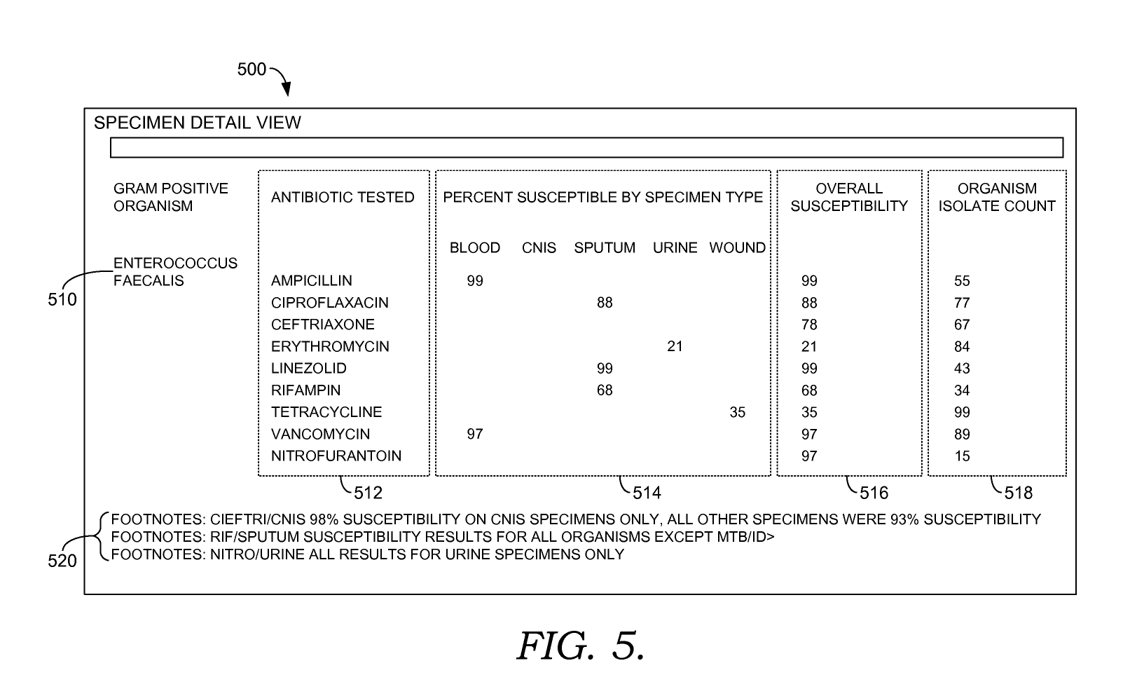

Each of the organisms in the organism display area 414 is selectable. Upon selecting an organism, the user is presented with a graphical user interface detailing additional information about the organism. FIG. 5 depicts an exemplary GUI 500 that presents this kind of detailed information. The GUI 500 includes an identification area 510 that identifies the organism that is the subject of the detail view. The GUI 500 also has an antimicrobial area 512 that presents a list of antimicrobials that were tested against the organism. A susceptibility rate by specimen type display area 514 breaks down the susceptibility rates of the organism against the different antimicrobials by specimen type. Specimen types may include blood, central nervous system (CNS) fluids, urine, wound, bile, feces, and the like.

An overall susceptibility rate display area 516 presents the overall susceptibility rate of the organism against each of the antimicrobials regardless of specimen type. An organism isolate count display area 518 presents the number of isolates of the organism tested against each of the antimicrobials. Additionally, the footnote display area 520 presents personalized information about the organism and/or antimicrobials. The information may be personalized at a facility level, a unit level, an end-user role level, a patient level, and the like.

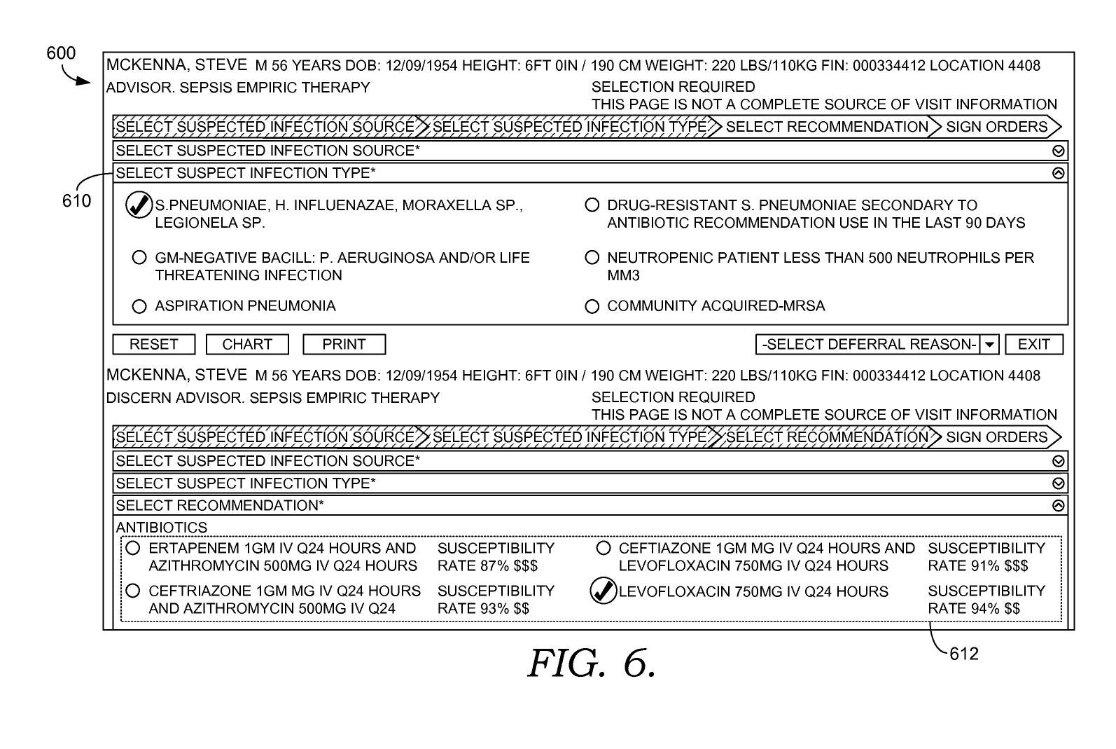

Continuing, FIG. 6 depicts an exemplary GUI 600 that illustrates yet another use of antibiogram information. The GUI 600 depicts a suspected infection order form used by clinicians during the initiation of empiric therapy. In area 610 of the order form, a clinician selects a suspected infection type. The selected infection type may be based on a suspected infection source. For example, a patient may present to the emergency room with pneumonia. The patient does not have a history of prior hospitalizations so the clinician suspects it may be a community-acquired pneumonia. The clinician proceeds to culture the patient and sends the culture to the lab but wants to initiate empiric therapy before the patient gets worse. The clinician selects the suspected infection type of S. pneumonia, H. Influenzae, Moraxella sp., and Legionella sp. based on the suspicion of community-acquired pneumonia.

In one aspect, antibiogram information stored in association with the healthcare facility's data store is used to determine antimicrobials that are effective against the selected organisms. In another aspect, the clinician's customized antibiogram is used to determine antimicrobials that are effective against the selected organisms. Antibiogram information, either at a facility level or customized, is also used to determine susceptibility rates of the organisms against the antimicrobials, and costs associated with the antimicrobials. This information is presented in the antimicrobial display area 612. For example, the antimicrobial display area 612 presents antimicrobials that are effective against the suspected organisms, susceptibility rates of those antimicrobials, and a cost indication of the antimicrobials. The presentation of this information helps the clinician to select effective antimicrobials that are reasonably priced.

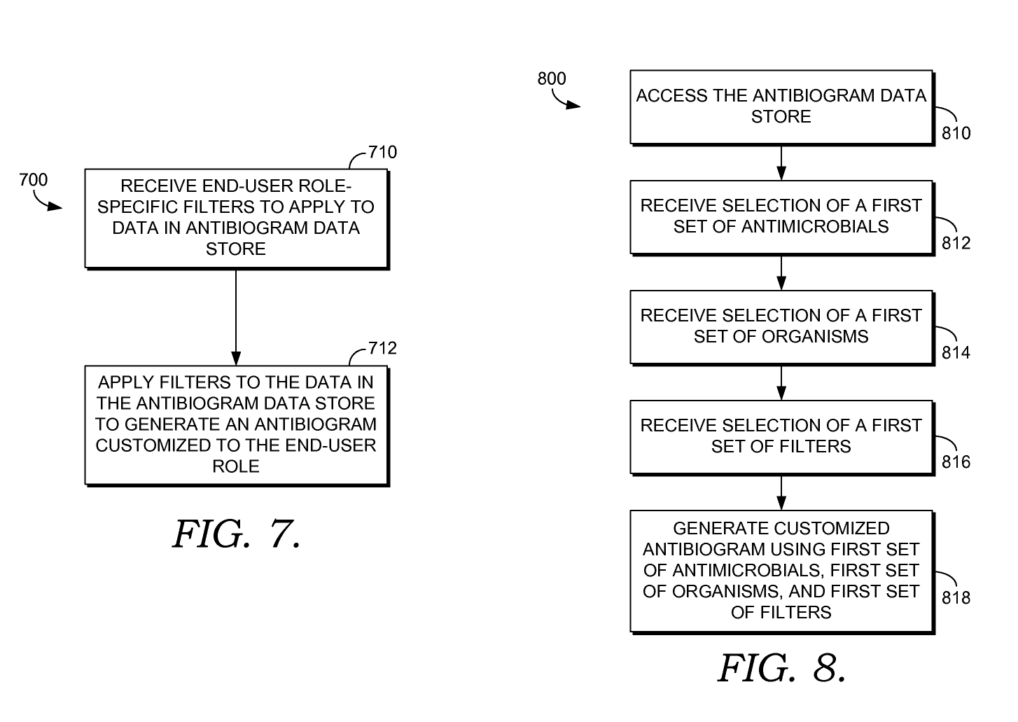

Turning now to FIG. 7, a flow diagram is depicted of an exemplary method 700 of utilizing a healthcare facility's antibiogram data store to generate a customized antibiogram. At a step 710, one or more user-selected filters are received by a receiving component such as, for example, the receiving component 218 of FIG. 2. The filters are dependent on an end-user role. In one aspect of the invention, the filters may be received from personnel associated with the healthcare facility who are responsible for generating customized antibiograms for a variety of different end-user roles. The one or more filters may comprise organism type, antimicrobial type, date range, encounter type, units within the healthcare facility, specimen type, and/or minimum isolate count. Further, end-user roles may include a pharmacist associated with the healthcare facility, a clinician associated with the healthcare facility, a therapist associated with the healthcare facility, and/or a nurse associated with the healthcare facility. Roles may be further stratified based on specialty, department, authorization level, and the like.

At a step 712, the received filters are applied to data in the antibiogram data store to generate the antibiogram customized to the end-user role. This may be done by a filter component such as the filter component 220 of FIG. 2. The antibiogram may be presented to a user upon verification of the user's role. For instance, a nurse may wish to access antibiogram information. An antibiogram customized to nurses is presented upon verification that the nurse works at the healthcare facility in a nursing capacity.

FIG. 8 depicts a flow diagram of an exemplary method 800 of using information stored in association with a healthcare facility's antibiogram data store to generate a customized antibiogram. At a step 810, the antibiogram data store is accessed. The antibiogram data store comprises a listing of susceptibility rates of one or more organisms, cultured within the healthcare facility, to one or more antimicrobials. The antimicrobials may be limited to those antimicrobials carried by the healthcare facility's pharmacy. The data store may also store information concerning the healthcare facility's costs for the different antimicrobials.

At a step 812, a selection of a first set of antimicrobials of the one or more antimicrobials is received. The first set of antimicrobials selected is dependent upon an end-user role. For example, a wide array of antimicrobials may be selected if the end user is an infectious disease specialist, while a more limited array of antimicrobials may be selected if the end user is a respiratory therapist (i.e., only those antimicrobials used in treating respiratory infections may be selected). The first set of antimicrobials may include cost indicators indicating the cost associated with using each of the antimicrobials. The cost indicators may comprise one or more dollar signs—the more dollar signs associated with an antimicrobial, the higher the cost.

At a step 814, a selection of a first set of organisms of the one or more organisms is received. Again, the first set of organisms may be dependent upon the end-user role. Using the same example as above, a wide variety of organisms may be selected if the end user is an infectious disease doctor, and a more limited variety may be selected if the end user is a respiratory therapist (i.e., only those organisms typically associated with respiratory diseases). The first set of organisms includes the susceptibility rates of the organisms against one or more of the selected antimicrobials.

At a step 816, a selection of a first set of filters to be applied to the information stored in association with the antibiogram data store is received; the first set of filters is dependent upon the end-user role. The first set of filters may comprise date range filters, unit filters, patient filters, encounter type filters, specimen type filters, isolate count filters, and the like. At a step 818, an antibiogram customized to the end-user role is generated using the first set of antimicrobials, the first set of organisms, and the first set of filters. The customized antibiogram may be presented to the end user upon verification of the end user's role.

The customized antibiogram may be used to select antimicrobials for empiric therapy. For example, a selection of a suspected infection type may be received. The suspected infection type includes one or more organisms suspected of causing a patient's infection. The customized antibiogram can be used to determine antimicrobials that are effective against the suspected organisms. Additionally, the customized antibiogram can be used to determine cost indicators for each of the antimicrobials and susceptibility rates of the organisms against the antimicrobials. This information is presented to the end user who can utilize the information to effectively and efficiently select an appropriate antimicrobial or group of antimicrobials to treat the suspected infection.

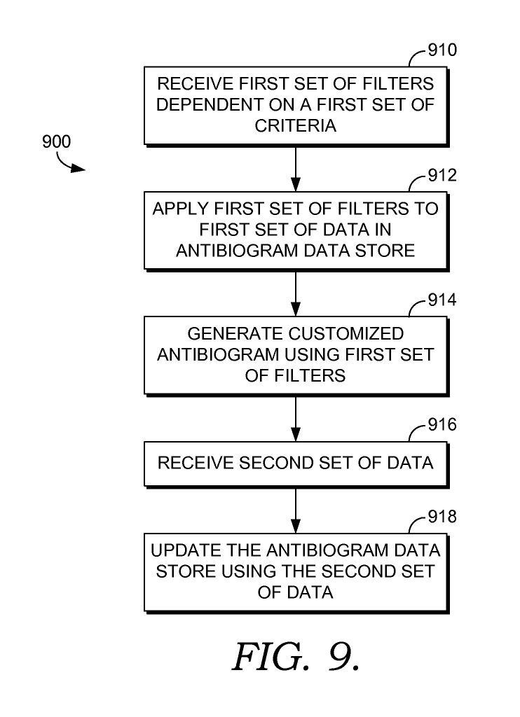

Turning to FIG. 9, a flow diagram is depicted of an exemplary method 900 of generating a customized antibiogram. At a step 910, a first set of filters is received from, for example, a clinician associated with the healthcare facility. The first set of filters is dependent on a first set of criteria. In turn, the first set of criteria may include a unit within the healthcare facility, an encounter type within the healthcare facility, a patient within the healthcare facility, or a role of the clinician within the healthcare facility. Encounter types may include emergency room visits, observational stays, post-discharge visits, post-surgical stays, and/or post-infection stays.

At a step 912, the first set of filters is applied to the data in the antibiogram data store, and, at a step 914, the customized antibiogram is dynamically generated using the first set of filters. As used throughout this specification, the term dynamically means occurring in near real-time. Upon generation, the customized antibiogram may be dynamically presented to the clinician enabling the clinician immediate access to customized antibiogram information.

At a step 916, new or modified antibiogram information is received by an update component such as the update component 224 of FIG. 2. And, at a step 918, the new or modified antibiogram information is used to update the antibiogram data store. The antibiogram data store may be updated per a fixed schedule such as daily, weekly, monthly, and the like. Alternatively, the antibiogram data store may be updated as soon as the new or modified antibiogram information is received. At this point, the method 900 returns to the step 912, and the outcome is that the clinician has access to up-to-date antibiogram information.

Upon presentation of the customized antibiogram, the clinician may select and apply additional filters to the customized antibiogram. Additional filters may include selection of a particular organism to view detailed information associated with the organism, selection of an antimicrobial to view additional information associated with the antimicrobial (common side-effects, cross-reactions with different medications, adverse drug reactions, and the like), or selection of a specimen type to view types of organisms typically cultured from the specimen and susceptibility rates of those organisms to different antimicrobials. Specimen types may include blood, CNS fluids, sputum, urine, and wound.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer storage media having computer-executable instructions embodied thereon that, when executed, facilitate a method of utilizing a healthcare facility's antibiogram data store to generate a customized antibiogram, the method comprising:
receiving one or more user-selected filters to apply to data in the antibiogram data store, the one or more filters dependent upon an end-user role; and
applying the one or more filters to the data in the antibiogram data store to generate the customized antibiogram, the customized antibiogram customized to the end-user role.

2. The media of claim 1, wherein the data in the antibiogram data store comprises information on susceptibility rates of one or more organisms, cultured within the healthcare facility, to one or more antimicrobials.

3. The media of claim 1, wherein the one or more filters comprise organism type and antimicrobial type.

4. The media of claim 3, wherein the one or more filters further comprise at least one of:
date range;
encounter type;
units within the healthcare facility;
specimen type; or
minimum result count.

5. The media of claim 1, wherein the end-user role comprises at least one of:
a pharmacist associated with the healthcare facility;
a clinician associated with the healthcare facility;
a therapist associated with the healthcare facility; or
a nurse associated with the healthcare facility.

6. The media of claim 1, wherein the customized antibiogram is used to direct empiric-therapy decisions.

7. One or more computer storage media having computer-executable instructions embodied thereon that, when executed, facilitate a method of using information stored in association with a healthcare facility's antibiogram data store to generate a customized antibiogram, the method comprising:
accessing the antibiogram data store, the antibiogram data store comprising a listing of susceptibility rates of one or more organisms, cultured within the healthcare facility, to one or more antimicrobials;
receiving a selection of a first set of antimicrobials of the one or more antimicrobials, the first set of antimicrobials selected dependent upon an end-user role;
receiving a selection of a first set of organisms of the one or more organisms, the first set of organisms selected dependent upon the end-user role;
receiving a selection of a first set of filters to be applied to the information stored in association with the antibiogram data store, the first set of filters applied dependent upon the end-user role; and
generating the customized antibiogram using the first set of antimicrobials, the first set of organisms, and the first set of filters.

8. The media of claim 7, wherein the one or more antimicrobials are stocked by the healthcare facility's pharmacy.

9. The media of claim 7, further comprising:
presenting the customized antibiogram on a user interface associated with the healthcare facility.

10. The media of claim 7, wherein the first set of antimicrobials includes the healthcare facility's cost for each antimicrobial of the first set of antimicrobials.

11. The media of claim 10, wherein the first set of organisms includes the susceptibility rate for each organism of the first set of organisms against the each antimicrobial of the first set of antimicrobials.

12. The media of claim 11, further comprising:
receiving a selection of a suspected infection type, the suspected infection type comprising a plurality of organisms of the first set of organisms suspected of causing a patient's infection, wherein the patient is being treated at the healthcare facility;
determining, using the customized antibiogram, a plurality of antimicrobials of the first set of antimicrobials that is effective against the plurality of organisms;
identifying, using the customized antibiogram, susceptibility rates of the plurality of organisms against each antimicrobial of the plurality of antimicrobials;
identifying, using the customized antibiogram, the healthcare facility's cost for the each antimicrobial of the plurality of antimicrobials; and
presenting the plurality of antimicrobials, the susceptibility rates of the plurality of organisms, and the healthcare facility's costs for the each antimicrobial on a user interface associated with the healthcare facility.

13. The media of claim 12, wherein the selection of the suspected infection type is received during an empiric therapy decision stage.

14. One or more computer storage media having computer-executable instructions embodied thereon that, when executed, facilitate a method of utilizing a healthcare facility's antibiogram data store to generate a customized antibiogram, the method comprising:
receiving a first set of filters to be applied to a first set of data in the antibiogram data store, the first set of filters dependent on a first set of criteria;
applying the first set of filters to the first set of data in the antibiogram data store;
dynamically generating the customized antibiogram using the first set of filters;
receiving a second set of data, the second set of data comprising new or modified antibiogram information; and
updating the antibiogram data store using the second set of data.

15. The media of claim 14, wherein the first set of filters is received from a clinician associated with the healthcare facility.

16. The media of claim 15, wherein the first set of criteria includes at least one of:
a unit within the healthcare facility;
an encounter type within the healthcare facility;
a patient within the healthcare facility; or
a role of the clinician within the healthcare facility.

17. The media of claim 16, wherein the encounter type includes at least one of the following encounters with one or more patients:
emergency room visit;
observational stay;
post-discharge visit;
post-surgical stay; or
post-infection stay.

18. The media of claim 15, further comprising:
incident to dynamically generating the customized antibiogram using the one or more filters, dynamically presenting the customized antibiogram on a user interface of a computing device associated with the clinician.

19. The media of claim 18, further comprising:
receiving a second set of filters to be applied to the customized antibiogram, the second set of filters dependent upon a second set of criteria, wherein the second set of criteria comprises at least one of organism type, antimicrobial type, or specimen type.

20. The GUI of claim 19, wherein the specimen type includes at least one of blood, central nervous system, sputum, urine, or wound.
